(19) United States
(12) Patent Application Publication
(10) Pub. No.: US 2008/0078963 A1
(43) Pub. Date: Apr. 3, 2008

(54) Optical sensor for detecting a medium

(75) Inventors: Koji Niioka, Nagano-Ken (JP); Takuya Yasue, Matsumoto-shi (JP); Hitoshi Igarashi, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/903,842

(22) Filed: Sep. 25, 2007

(30) Foreign Application Priority Data
Sep. 25, 2006 (JP) 2006-258826

(51) Int. Cl. G01N 21/86; G03G 15/00

(52) U.S. Cl. 250/559.36; 399/45

(57) ABSTRACT

An optical sensor used for detected the end portion of a medium includes a light-emitting unit for emitting light, a light-receiving unit for receiving the light emitted by the light-emitting, a pair of tubular portions, which are made of a material capable of transmitting light, covering the light-emitting unit and the light-receiving unit, and a base portion coupled to the tubular portions, wherein a gap between opposing faces of the pairs of tubular portions is in the range of about 6 mm to about 10 mm, and wherein the optical sensor detects an end portion of the medium when the end portion of the medium passes between the light-emitting unit and the light-receiving unit.

### CROSS REFERENCES TO RELATED APPLICATIONS

Applicant hereby claims priority to Japanese Patent Application No. 2006-258826, filed Sep. 25, 2006, which is expressly incorporated by reference herein.

### BACKGROUND

1. Technical Field

The present invention relates to an optical sensor for detecting a medium on a device comprising one or more of a printer, scanner, facsimile machine, or copier.

2. Related Art

In ink jet printers and other devices that print on printing media such as printing paper, it is required to detect whether a printing medium is supplied and to print on an appropriate portion of the printing medium. In order to detect whether the printing medium is supplied, a paper end sensor (hereinafter, referred to as a PE sensor) that is located a predetermined distance apart from a paper feed hopper on a downstream side of a paper feeding direction and located toward an upstream side relative to a print head (see JP-A-2004-351898; paragraph number 0033, FIG. 6, and the like).

In the PE sensor disclosed in JP-A-2004-351898, a printing medium is brought into contact with a lever and the lever is rotated in accordance with the contact. A light-shielding unit is provided in the lever so as to block or allow transmission of received light. Accordingly, whether the received light changes, that is, the printing medium is supplied is detected. In other words, a mechanical type (contact type) PE sensor using rotation of a lever is disclosed in JP-A-2004-351898.

In the mechanical type (contact type) PE sensor, it takes some time for the printing medium to rotate after contacting the lever. In other words, when the printing medium is supplied from the paper feed hopper side, the lever collides with the printing medium in accordance with the supply of the printing medium. However, in the collision, a collided portion of the printing medium deforms into a deformed shape. In addition, in order to rotate a lever at rest, a predetermined time from the above-described collision is required due to inertia of the lever.

Here, when the speed of supply of the printing medium is increased so as to improve the throughput of the printing, the printing medium is transported during a predetermined time period defined from the time point at which the printing medium collides with the lever to the time point at which the supply of the printing medium is detected as the lever rotates. Thus, when information on the time point at which the supply of the printing medium is detected is directly used, an error such as a discrepancy of a printing position occurs due to the existence of the predetermined time period. Accordingly, in a detection process using a known PE sensor, predetermined correction for the detected location, the detected time, or the like is performed in accordance with the speed of supply of the printing medium.

However, because this correction process should be set for each supply speed of the printing medium, the correction process can become complicated. In addition, when the supply speed of the printing medium is increased, there is an increased likelihood of breakage of the printing medium or of the production of a collision mark on the printing medium caused when the printing medium collides with the lever.

### SUMMARY

In one aspect of at least one embodiment, the invention is directed to an optical sensor used for detecting a medium, the optical sensor including: a light-emitting unit for emitting light; a light-receiving unit for receiving the light emitted by the light-emitting unit; a first and a second tubular portion, which are made of a material capable of transmitting light, the first tubular portion covering the light-emitting unit and the second tubular portion covering light-receiving unit; and a base portion coupled to the first and second tubular portions. The distance between the opposing faces of the first and second tubular portion scan be in the range of about 6 mm to about 10 mm, and the optical sensor detects an end portion of the medium when the medium passes between the light-emitting unit and the light-receiving unit.

In another aspect of at least one embodiment, the invention is directed to an optical sensor used for detecting a medium, the optical sensor including: a light-emitting unit for emitting light; a light-receiving unit for receiving the light emitted by the light-emitting unit; a first and second tubular portion made of a material capable of transmitting light, the first tubular portion covering the light-emitting unit and the second tubular portion covering the light-receiving unit; and a base portion coupled to the first and second tubular portions. The optical sensor has an optical axis between the light-emitting unit and the light-receiving unit which is approximately parallel to the base portion and is positioned a distance from the base portion that is in the range of about 14 mm to about 19 mm, and the optical sensor detects an end portion of the medium when the end portion of the medium passes between the light-emitting unit and the light-receiving unit.

In another aspect of at least one embodiment, the invention is directed to an optical sensor used for detecting a medium, the optical sensor including: a light-emitting unit for emitting light; a light-receiving unit for receiving the light emitted by the light-emitting unit; a first and second tubular portion made of a material capable of transmitting light, the first tubular member covering the light-emitting unit and the second tubular member covering light-receiving unit; and a base portion coupled to the first and second tubular members. At least one slit member that has a plurality of wall faces, covers the light-emitting unit or the light-receiving unit so as to block light using the wall faces, and has a slit on one face of the wall faces for allowing transmission of light is disposed inside the pair of tubular portions and a width of the slit is in the range of approximately 0.6 mm to approximately 0.9 mm. In addition, the optical sensor detects an end portion of the medium when the end portion of the medium passes between the light-emitting unit and the light-receiving unit.

In another aspect of at least one embodiment, the invention is directed to a device including: the optical sensor described above, a transport unit for transporting the medium, and a control unit that controls one or more a motors included in the transport unit on the basis of optical sensor detection of an end portion of the medium in a transport direction of the medium.

### BRIEF DESCRIPTION OF THE DRAWINGS

The invention will be described with reference to the accompanying drawings, wherein like numbers reference like elements.

FIG. 1 is a side view schematically showing a configuration of a printer according to an embodiment of the invention.

FIG. 2 is a schematic diagram showing disposition of a driving system and a PE sensor shown in FIG. 1.

FIG. 3 is a side view showing the configuration of the PE sensor shown in FIG. 2.

FIG. 4 is a front view showing the configuration of the PE sensor shown in FIG. 2.

FIG. 5 is a plan view showing the configuration of the PE sensor shown in FIG. 2.

FIG. 6 is a perspective view showing a configuration of a slit member of the PE sensor shown in FIG. 2.

FIG. 7 is a partial sectional view showing the configuration of the PE sensor shown in FIG. 2.

FIG. 8 is a plan view showing a known PE sensor.

FIG. 9 is a diagram showing gap characteristics of the known PE sensor.

FIG. 10 is a diagram showing gap characteristics of the PE sensor in one embodiment of the invention shown in FIG. 2.

FIG. 11 is a diagram showing media characteristics of the known PE sensor.

FIG. 12 is a diagram showing media characteristics of the PE sensor in one embodiment of the invention shown in FIG. 2.

FIG. 13 is a diagram showing a relationship between paper feeding speed in the PE sensor and a characteristic of length from a rear end.

### DETAILED DESCRIPTION

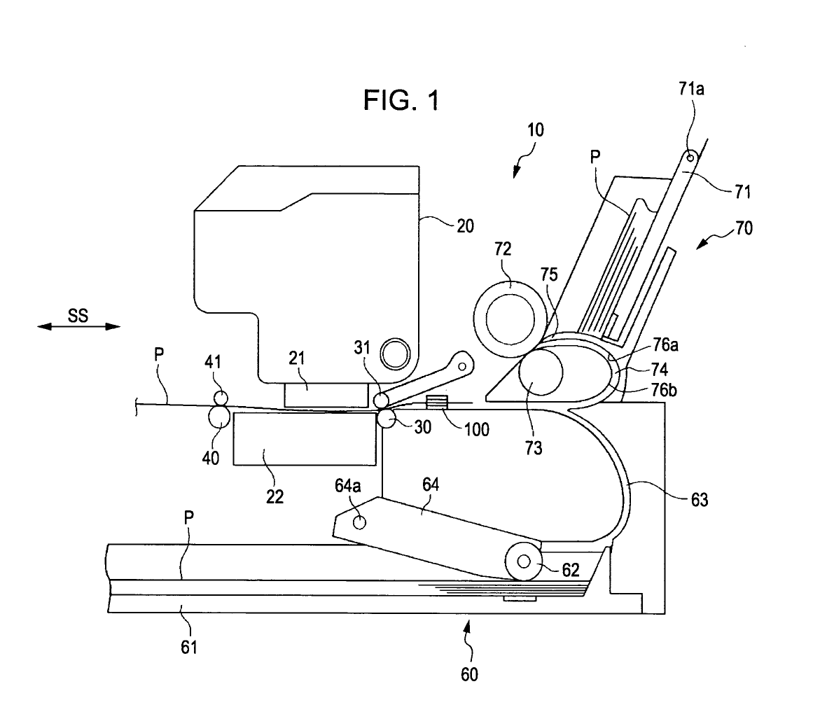

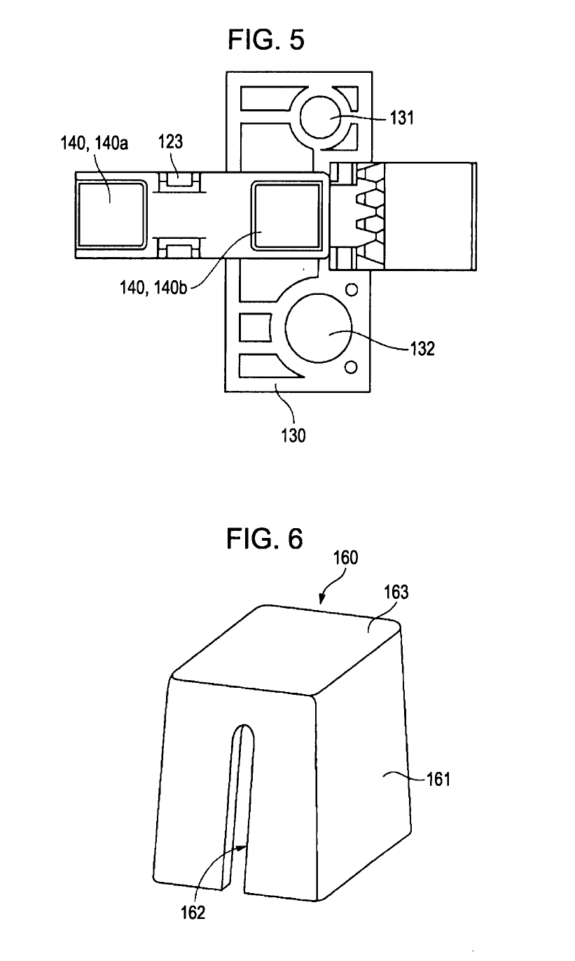

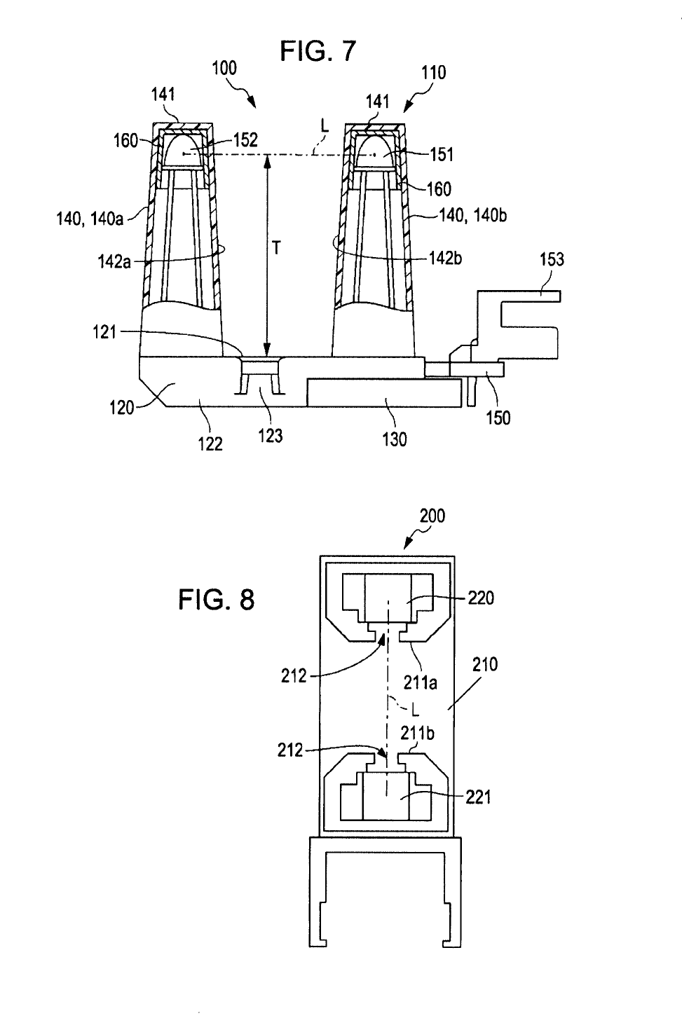

Hereinafter, an optical sensor and a printer according to embodiments of the present invention will be described with reference to FIGS. 1 to 13.

According to one embodiment of the invention shown in FIG. 1, the printer 10 is an ink jet printer that performs a printing operation by ejecting ink droplets onto a printing medium P. The invention is not limited to a printer, but may also be directed to other devices in which the end portion of a medium is detected by an optical sensor, such as a scanner, facsimile machine, or copier, or a combination thereof. Furthermore, the invention is not limited to a printing medium, but may also be directed toward other media for use in the aforementioned devices.

The printer 10 is configured such that the printing medium P can be supplied from both sides including a front side (a left side in FIG. 1) and a rear side (a right side in FIG. 1). The printer 10 includes a carriage 20 mounted with a print head 21 for ejecting ink droplets, a paper feed (PF) driving roller 30 transporting the printing medium P supplied from a paper feed hopper 71 or the like, to be described later, in a secondary scanning direction, a PF driven roller 31 transporting the printing medium P together with the PF driving roller 30, a discharge driving roller 40 and a discharge driven roller 41 which discharge the printing medium P outside the printer 10, a platen 22 facing an ink ejecting face (a lower side in FIG. 1) of the print head 21, a front side paper feed mechanism 60 for supplying the printing medium P toward a printing area printed by the print head 21 from the front side, a rear side paper feed mechanism 70 for supplying the printing medium P toward the printing area from the rear side, and a paper end detecting sensor 100 (hereinafter, referred to as a PE sensor) for detecting the passing or the like of the printing medium P supplied from the paper feed hopper 71 or the like.

Examples of the printing medium P of this embodiment include a transparent film such as a sticker, an one-hour photo (OHP) film, or the like in addition to plain paper used for printing an ordinary document, photo paper used for printing a photograph, and a paperboard thicker than the plain paper or the photo paper.

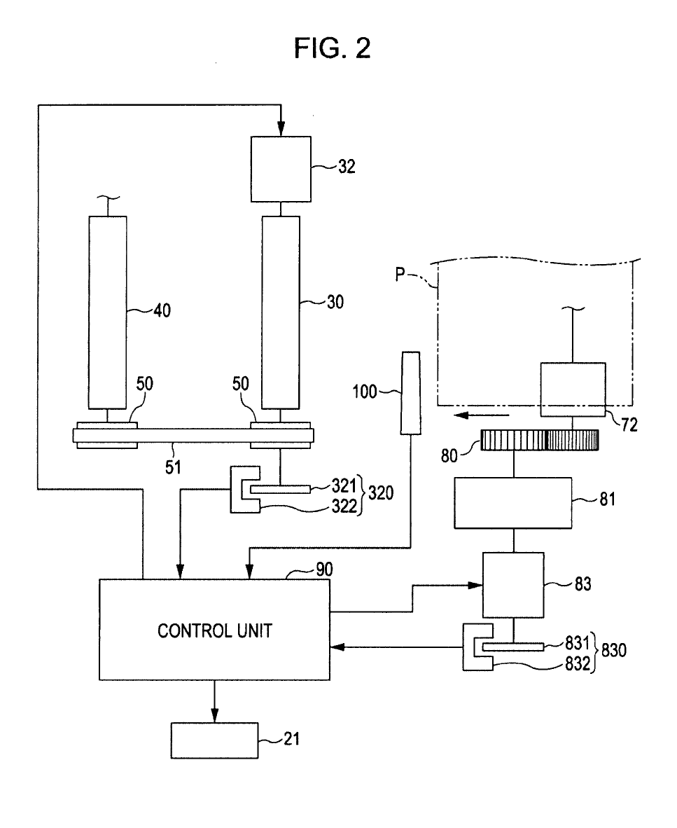

The PF driving roller 30, as shown in FIG. 2, is connected to a PF motor 32 directly or through a gear or the like that is not shown in the figure. The PF motor 32 according to this embodiment is a DC (direct current) motor. In this embodiment, the method of controlling the PF motor 32 can include, a pulse-width modulation (PWM) control method together with a proportional-integral-derivate (PID) control method used for controlling the current rotation speed (current number of revolutions) of the PF motor 32 to converge upon a target rotation speed (target number of revolutions). The method of PF motor control can combine proportional control, integral control, and derivative method. A PF driven roller 31 is urged by a spring, which is not shown in the figure, toward the PF driving roller 30 and rotates together with the PF driving roller 30.

The above-described PF driving roller 30, the PF driven roller 31, and the PF motor 32 form a paper transporting unit together with a discharge driving roller 40, a discharge driven roller 41, a front side paper feed roller 62, a rear side paper feed roller 72, a retard roller 73, an ASF motor 83, and the like, to be described later.

The discharge driving roller 40, as shown in FIG. 2, is connected to the PF driving roller 30 through a transmission mechanism such as a pulley 50 or a belt 51. The rotation of the discharge driving roller 40 is synchronized with that of the PF driving roller 30. That is, the discharge driving roller 40 rotates at the approximately same circumferential speed as the PF driving roller 30. The discharge driven roller 41 is urged toward the discharge driving roller 40 by a spring not shown in the figure and rotates together with the discharge driving roller 40.

The front side paper feed mechanism 60 includes a feeding cassette 61 in which the printing medium P supplied from the front side is set, a front side paper feed roller 62 that supplies the printing medium P loaded in the feeding cassette 61 inside the printer 10, and a transport path 63 through which the printing medium P incoming from the front side passes. The front side paper feed roller 62 is attached to a front end of an arm 64 configured to be pivotable around a rotation shaft 64a and contacts a top face of the printing medium P with pressure. In addition, the front side paper feed roller 62 transports the printing medium P inside the printer 10 until a front end of the printing medium P reaches the PF driving roller 30.

The rear side paper feed mechanism 70 includes a paper feed hopper 71 serving as a medium setting unit in which the printing medium P prior to a printing operation supplied from the rear side is set, a rear side paper feed roller 72 serving as a supply roller supplying the printing medium P on the paper feed hopper 71 toward a printing area printed by the print head 21, and a retard roller 73 used for preventing duplicate transport of the printing mediums P.

The rear side paper feed roller 72, as shown in FIG. 2, is connected to the ASF motor 83 serving as a supply motor through a train of gears 80 or a train of planet gears 81. In addition, the front side paper feed roller 62 is connected to the ASF motor 83 through the train of planet gears 81 or the like (In FIG. 2, the front paper feed roller 62 is not shown). In this embodiment, when the ASF motor 83 rotates in one direction by an operation of the train of planet gears 81, the rear side paper feed roller 72 is rotated, and when the ASF motor 83 rotates in the other direction, the front side paper feed roller 62 is rotated. The ASF motor 83 in this embodiment is a DC motor and is PWM-controlled and PID-controlled, like the PF motor 32.

The paper feed hopper 71 is a plate-shaped member on which the printing medium P can be placed and is configured to be pivotable around a rotation shaft 71a provided in the front end thereof. The retard roller 73 is disposed in a location facing a lower side of an inclination of the rear side paper feed roller 72 and is held in an arm to be rotatable, not shown in the figure, that is configured to be pivotable around a rotation shaft not shown in the figure. By rotation of a cam not shown in the figure, the paper feed hopper 71 pivots around the rotation shaft 71a as well as the arm in which the retard roller 73 is held. Depending on the pivoting, a lower end portion of the paper feed hopper 71 is urged toward or away from the rear side paper feed roller 72. In addition, depending on the pivoting, the retard roller 73 is brought into contact with or is separated from the rear side paper feed roller 72. In other words, depending on the rotation of the cam, the lower end portion of the paper feed hopper 71 and the retard roller 73 are lifted upward or downward.

Below the paper feed hopper 71, a reverse path 74 is provided. The reverse path 74 is a portion through which the printing medium P whose one face has been printed passes when double sided printing is performed. In other words, the printing medium of which one face facing the print head 21 has been printed is returned to an upstream side of the paper transport. In this returning process, an end portion (rear end portion) of the printing medium P on the upstream side is inserted into the reverse path 74. When the printing medium P passes through the reverse path 74, a side view of the printing medium P forms a loop while the printing medium moves. A rear end portion of the printing medium P prior to passing the reverse path 74 becomes a front end portion located on the downstream side after passing through the reverse path 74, and the back face of the printing medium becomes a front face. Then, the printing medium is transported on the downstream side while maintaining this state.

In order to form the reverse path 74, a guide 75 for guiding the returned printing medium P to a reverse path 74 side is provided below the paper feed hopper 71. In addition, a pair of guide faces 76a and 76b for forming the reverse path 74 is provided below the paper feed hopper 71. When the printing medium P is guided from the guide 75 along the first guide face 76a of the pair of the guide faces 76a and 76b, the printing medium P progresses (rotates) along the first guide face 76a, and thereby the first guide face 76a becomes continuous to a top face of the platen 22. In addition, the second guide face 76b of the pair of the guide faces 76a and 76b faces the first guide face 76a. Although the second guide face 76b is located below the first guide face 76a around the guide 75, the second guide face 76b becomes located above the first guide face 76a, as the second guide face 76b progresses (rotates).

The above-described first and second guide faces 76a and 76b have sufficient widths for passing the printing medium P, support portions (not shown in the figure) are provided on both sides thereof, and a member for forming the first guide face 76a and a member for forming the second guide face 76b are connected thereto. A reverse paper feed mechanism is constituted by the reverse path 74, the guide 75, and the like.

In addition, the printer 10, as shown in FIG. 2, a PF encoder 320 for detecting the number of revolutions and the like of the PF motor 32, and an ASF encoder 830 for detecting the number of revolutions and the like of the ASF motor 83. The PF encoder 320 includes a rotary scale 321 fixed to a rotation shaft of the PF driving roller 30 and a photo sensor 322 having a light-emitting element and a light-receiving element which are not shown in the figure. The ASF encoder 830 includes a rotary scale 831 fixed to an output shaft of the ASF motor 83 and a photo sensor 832 having a light-emitting element and a light-receiving element which are not shown in the figure. Output signals transmitted from the PF encoder 320 and the ASF encoder 830 are input to a control unit 90 that performs various control operations for the printer 10.

In this embodiment, rectangular pulse signals are output from the PF encoder 320 and the ASF encoder 830, or a rectangular pulse signal is generated by the control unit 90 on the basis of output signals transmitted from the PF encoder 320 or the ASF encoder. Then, the number of revolutions of the PF motor 32 or the ASF motor 83 and the like are detected by this rectangular pulse signal.

As shown in FIG. 2, the PF pulse signal output from the PF encoder 320 and the ASF pulse signal output from the ASF encoder 830 are input to the control unit 90. This control unit 90 has a CPU, a memory, an interface, an ASIC (Application Specific Integrated Circuit), a bus, a timer, and the like which are not shown in the figure, and is responsible for driving of the PF motor 32, the ASF motor 83, the print head 21, and the like. The control unit 90 corresponds to a control unit.

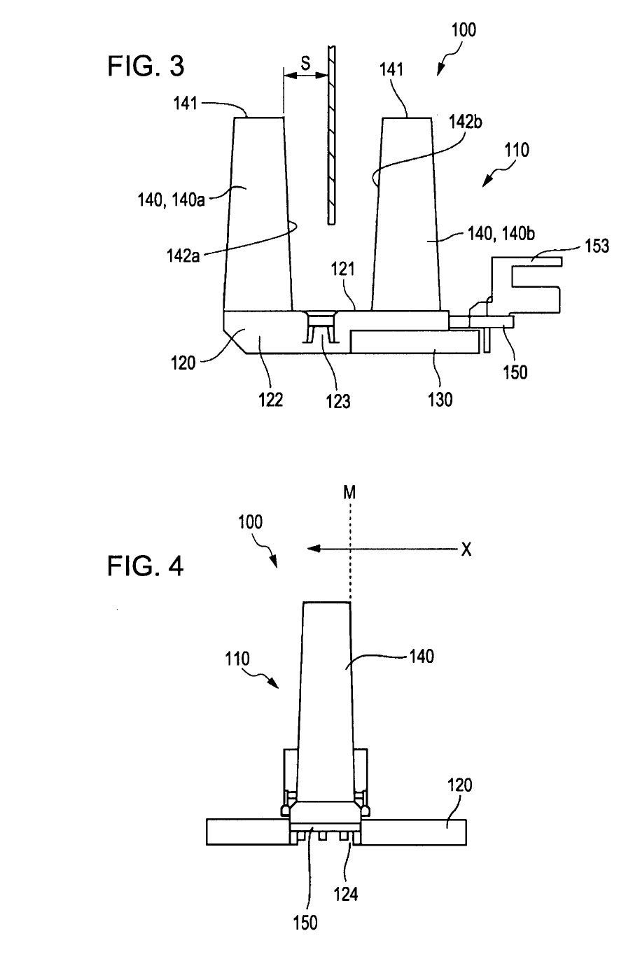

FIGS. 3 to 7 are diagrams showing the configuration of a PE sensor 100 used as an optical sensor according to an embodiment of the invention. The PE sensor 100, as shown in FIGS. 1 and 2, is located between the rear side paper feed roller 72 and the PF driving roller 30. In addition, the PE sensor 100 is provided on a downstream side of the paper feeding direction relative to a portion in which the printing medium P from the paper feed hopper 71 side, the printing medium P from the transport path 63, and the printing medium P from the reverse path 74 are joined together. The PE sensor 100 detects an end portion in the widthwise direction of the printing medium P passing between the light-emitting element 151 and the light-receiving element 152.

The PE sensor 100, as shown in FIG. 3, has a housing 110. The housing 110 includes a base portion 120, an attachment and fixation portion 130, and a tubular portion 140. The housing 110 is formed integrally and is made of a material, which can be a resin through which light can pass. The resin may be comprised of polycarbonate. Alternatively, a resin other than polycarbonate may be used. Only the tubular portion 140 is required to be able to pass light. Since the housing 110 is required to enable the light-receiving element 152 to receive strong light emitted from the light-emitting element 151, as a material thereof, a material that is slightly transparent under natural light may be used so as to sufficiently pass the light emitted from the light-emitting element 151.

The base portion 120 constituting the housing 110 is a portion, the inside (concaved portion 124) of which a substrate 150 is attached to, and is formed such that a section thereof has a concave shape. In addition, on a top face 121 (a portion that is inserted between a pair of side walls 122) of the base portion 120, a through hole, which is not shown in the figure, is provided in correspondence with an attachment region of the above-described tubular portion 140. Thus, the light-emitting element 151 or the light-receiving element 152 can be inserted into the inside of the tubular portion 140 through the through hole.

In the side wall 122, a press portion 123 is provided. The press portion 123 has a base on a lower side departed away from the top face 121. A portion of the press portion 123 on the top face side 121 is disconnected from the side wall 122 and the top face 121. When the substrate 150 is pressed toward the top face 121, the press portion 123 is bent while the base thereof is used as a supporting point. On the other hand, when the substrate 150 is brought into contact with the top face 121 of the press portion 123, the press portion 123 presses the substrate 150. Accordingly, the substrate 150 is attached securely to the base portion 120. In this embodiment, since a pair of tubular portions 140 is provided, a pair of through holes is provided.

An attachment and fixation portion 130 disposed to be approximately vertical to an extension direction of the base portion 120. The attachment and fixation portion 130 is for attaching the PE sensor 100 to a predetermined region of the printer 10. The attachment and fixation portion 130 is formed to be thicker than the base portion 120 and the tubular portion 140. In addition, in the attachment and fixation portion 130, two hole portions 131 and 132 are provided. Thus, the PE sensor 100 can be attached and fixed to a predetermined attachment area, for example, through a screw or the like.

When the PE sensor 100 is attached to the predetermined region of the printer 10, it is possible to adjust the attachment region of the PE sensor 100 while the attachment and fixation portion 130 is slightly shifted. In this embodiment, the hole portion 132 is formed to be a bit long hole. However, the hole portion 132 may be formed to have a circular hole 132.

In this embodiment, the adjustment of the attachment position (correction of the attachment position) of the PE sensor 100 can be performed only once while the detection result of the PE sensor 100 is monitored. By performing the adjustment (correction) only once, correction for non-uniform detection of a paper end for each transport speed of the printing medium P is omitted.

In a part of the base portion 120 in which the through hole is formed, the tubular portion 140 is coupled to and may be formed integrally with the base portion. The tubular portion 140 extends in a direction of the normal line of the top face 121 of the base portion 120. The tubular portion 140 is formed to have a bottom-covered tubular shape. In other words, on a side of the tubular portion 140 departed farthest from the through hole, a bottom portion 141 is provided, and a part of the tubular portion on the through hole side is formed as an opening (not shown) communicating with the through hole.

In this embodiment, the through hole on one side is formed to be leaned toward one end side of the base portion 120. In addition, an outer face of one end side of the tubular portion 140 communicating with the through hole on one side is provided to be approximately the same as a section of the one end side of the base portion 120.

The section size of the tubular portion 140 is formed to be the maximum on the side of its base portion 120 which serves as a base. In addition, the section size of the tubular portion 140 is formed to decrease as the tubular portion 140 is departed away from the base portion 120. In other words, as the tubular portion 140 becomes spaced apart from the base, the tubular portion 140 is formed to be gradually thin. In this embodiment, the section of the tubular portion 140 is formed to have an approximately square shape. In addition, the size of one side of the tubular portion 140 between its outer faces in the base portion is, for example, formed to be 5.15 mm (about 5.15 mm). In addition, the size of height of the tubular portion 140, for example, is about 19.2 mm. In addition, the size of one side of the tubular portion 140 between its outer faces on the side of a protruded end departed from the bottom is, for example, formed to be 4.8 mm (about 4.8 mm).

In this embodiment, the pair of the tubular portions 140 is formed to have a predetermined gap between its opposing faces 142a and 142b. The gap between the opposing faces 142a and 142b is formed such that the printing medium P supplied from the paper feed hopper 71 can pass through, the printing medium P supplied from the transport path 63 can pass through, and the printing medium P supplied from the reverse path 74 can pass through. The size of the gap between the opposing faces 142a and 142b may be set to 8 mm (about 8 mm) in the base of the tubular portion 140. However, the size of the gap between the opposing faces 142a and 142b is not limited to 8 mm (about 8 mm). When the size of the gap between the opposing faces 142a and 142b is in the range of approximately 6 mm to approximately 10 mm, the printing medium P can pass well (paper passing can be maintained well) through the gap.

To a concaved portion 124 of the base portion 120, the substrate 150 is attached and fixed. In this substrate 150, the light-emitting element 151 and the light-receiving element 152 are installed such that the light-emitting element and the light-receiving element are electrically connected to each other. In addition, a connector 153 is connected to the other end of the base portion 120. The connector 153 is connected to a power supply unit and an ASIC which are not shown in the figure. The power supply unit supplies power required for an operation of the light-emitting element 151 and the light-receiving element 152 and makes it possible to output an output signal from the light-receiving element 152 to the ASIC side.

The light-emitting element 151 corresponds to the light-emitting unit, the light-receiving element 152 corresponds to the light-receiving unit.

Inside the above-described tubular portion 140, a slit member 160 is inserted. The material of the slit member 160 is steel such as stainless steel. However, the material of the slit member 160 is not limited to steel, and may be any material that can block light. The slit member 160 is formed to have a tubular shape and may have its bottom covered. The size of the slit member 160 is provided such that the slit member 160 can be inserted into the above-described tubular portion 140 and positioned inside the tubular portion 140. When the slit member 160 is inserted into the tubular portion 140, a bottom 163 of the slit member 160 is collided with a bottom 141 of the tubular portion 140. However, the slit member 160 may be stopped at an inside portion of the tubular portion 140 close to the bottom 141 of the tubular portion 140 by being locked with an inner wall of the tubular portion 140.

On one side 161 of the slit member 160, a slit 162 is provided. The slit 162 is formed to face the bottom side 163 from an opening portion departed from the bottom 163. The slit 162 is disposed to face the above-described opposing faces 142a and 142b inside the tubular portion 140. The width size of the slit 162 is 0.7 mm (about 0.7 mm). However, the width size of the slit 162 is not limited to 0.7 mm (about 0.7 mm) and may be in the range of approximately 0.6 mm to approximately 0.9 mm. When the width size of the slit 162 is in the range of approximately 0.6 mm to approximately 0.9 mm, light emitted from the light-emitting element 151 can be sufficiently blocked by a portion other than the slit 162. In addition, when the width size of the slit 162 is in the above-described range, an excellent sensitivity (detection precision) can be acquired by eliminating an effect of a dark current in the light-receiving element 152 or external light.

The height from the bottom 163 of the slit member 160 to the opening portion may be any size for which a light blocking property of a portion other than the slit 162 is excellent and the light-emitting element 151 or the light-receiving element 152 can be inserted.

Inside the slit member 160, the light-emitting element 151 or the light-receiving element 152 is disposed. In this embodiment, in the slit member 160 placed inside one tubular portion 140a, the light-receiving element 152 is disposed, and in the slit member 160 placed inside the other tubular portion 140b, the light-emitting element 151 is disposed. A slit 162 of the slit member 160 placed inside the one tubular portion 140a and a slit 162 of the slit member 160 placed inside the other tubular portion 140a have the same width size. It is preferable that common slit members are used as both the slit members 160.

The optical axis is defined as the path of light between the light-emitting element and the light-receiving element. In this embodiment, the optical axis L of the light-emitting element 151 and the light-receiving element 152 which are disposed inside the slit members 160 are disposed to be parallel to the base portion 120. The optical axis L is disposed in a position 16.5 mm (about 16.5 mm) spaced apart from the top 121 of the base portion 120. On the other hand, an optical axis between the light-emitting element 220 and the light-receiving element 221 included in a known mechanical PE sensor 200 (see FIG. 8) is disposed in a position about 7 mm to about 8 mm spaced apart from the top 121 of the base portion 120. Thus, the optical axis L of the PE sensor 100 according to this embodiment is formed to be farther from the base portion 120 than that of the known PE sensor 200.

The position of the above-described optical axis is not limited to the position 16.5 mm (about 16.5 mm) spaced apart from the top 121 of the base portion 120 and may be any position apart in the range of approximately 14 mm to approximately 19 mm from the top 121 of the base portion 121.

The structure of the PE sensor 200 which is different from that of the above-described PE sensor 100 is shown in FIG. 8. As shown in FIG. 8, in the known PE sensor 200, a light-emitting element 220 and a light-receiving element 221 are not completely covered by an attachment portion 210, and slits 212 are provided in opposing faces 211a and 211b. Accordingly, the light-emitting element 220 and the light-receiving element 221 face each other through the slits 212 and charges generated by frictional contact with a lever pass through the slits, there is a problem that the detection precision deteriorates. In the known PE sensor 200, a gap between the opposing faces 211a and 211b is formed to be about 5 mm to about 6 mm. In the known PE sensor 200, the width of the slits 212 is formed to be 0.5 mm (about 0.5 mm).

In another aspect of an embodiment of the invention, a light-blocking member is disposed in each of the first and second tubular portions. Each of the light-blocking members includes a light-passing opening disposed in one of the walls of the light-blocking member. The light-passing opening can be in the shape of a slit, an approximately square-shaped window, or a circular-shaped window. The shape of the light-passing opening is not limited to these above-mentioned shapes. Furthermore, the light-passing openings may face each other on opposing sides of the light-blocking members disposed in each of the tubular portions.

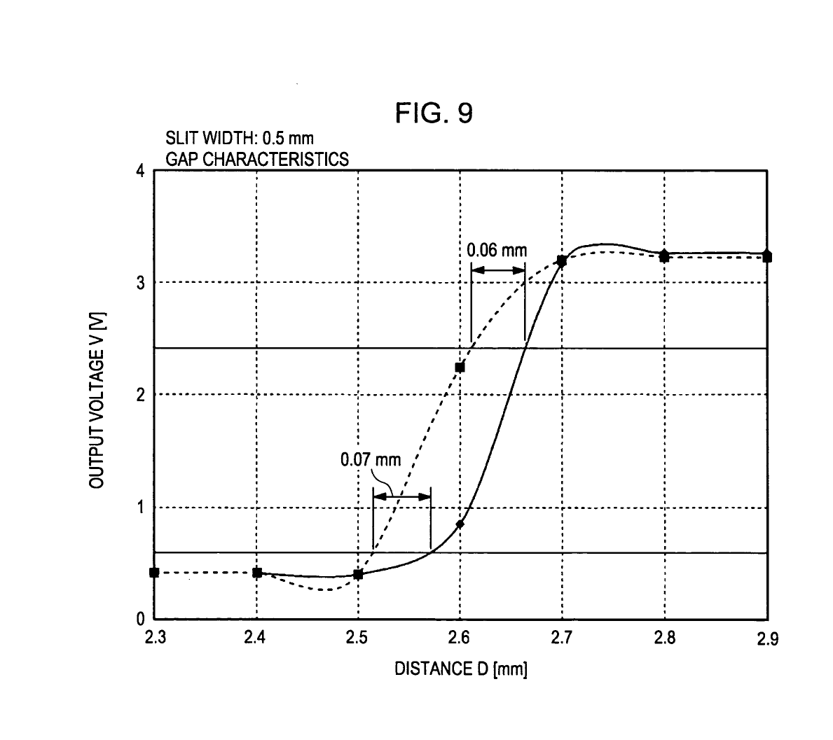

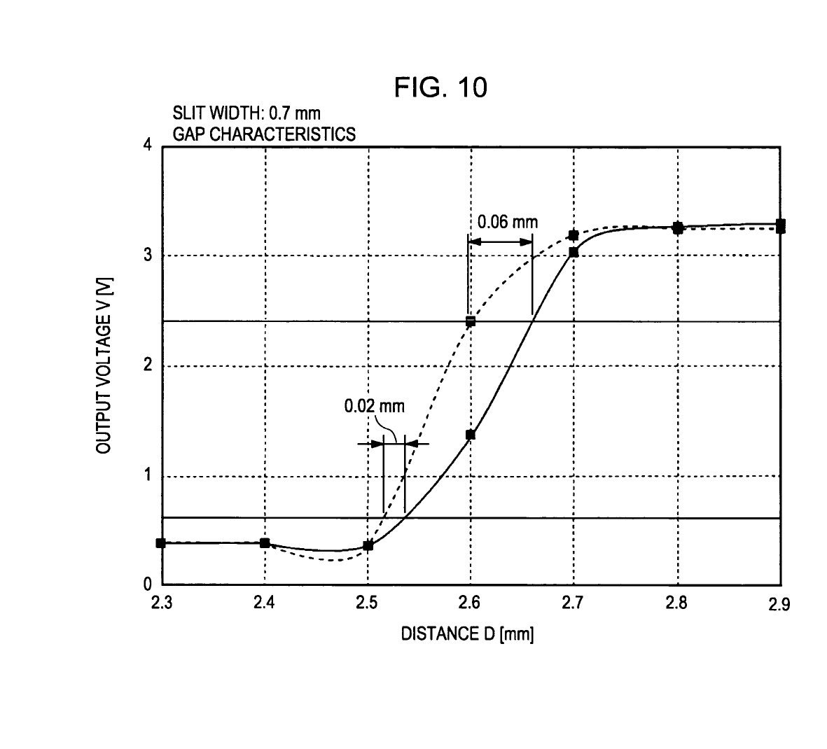

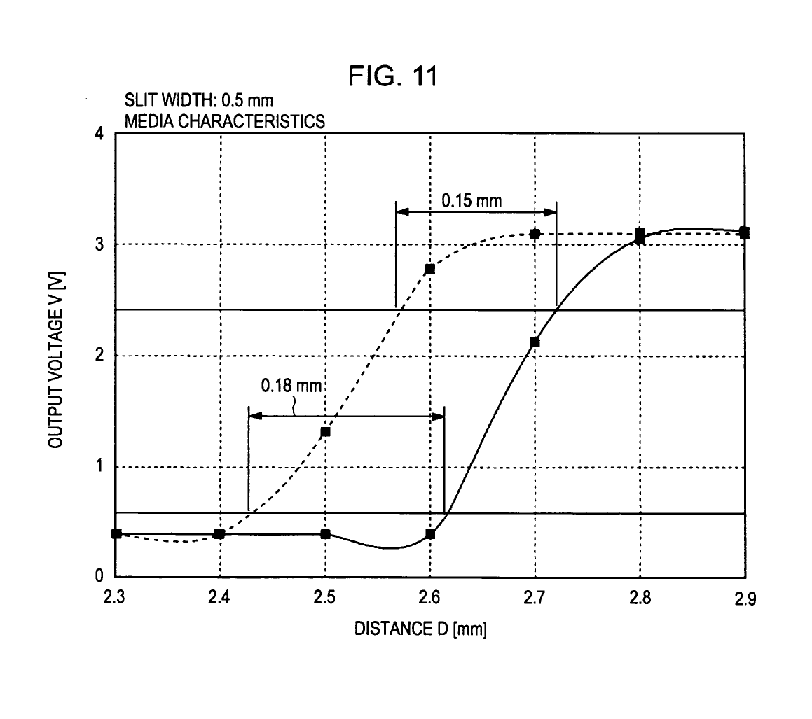

Subsequently, characteristics of the PE sensor 100 will be described with reference to FIGS. 9 to 13. FIG. 9 shows gap characteristics of the known PE sensor 200. In addition, FIG. 10 shows gap characteristics of the PE sensor 100 according to this embodiment.

In these figures showing the characteristics of the PE sensors, “D” denotes a position of an end portion of a printing medium P relative to a reference position (a portion denoted by a dotted line M In FIG. 4) in a case where the printing medium P is transported in a paper feeding direction (direction X in FIG. 4). In addition, an output voltage denotes a voltage level detected by a light-receiving element 152 side in a case where the printing medium P is transported in the paper feeding direction.

In FIGS. 9 and 10, a dotted line denote a case where a distance (gap, distance S in FIG. 3) from an opposing face 142a or 211a disposed on a side on which a light-emitting element 151 or 220 is disposed is about 4 mm when the printing medium P is supplied. In addition, a solid line denotes a case where the distance S from the opposing face 142a or 211a disposed on a side on which the light-emitting element 151 is disposed is about 7.5 mm. In FIGS. 9 and 10, numbers in the graphs show a difference (gap error) of positions exceeding threshold voltage levels (0.6 V and 2.4 V) in cases where the distance S is about 4 mm and about 7.5 mm.

As shown in FIG. 9, in the known PE sensor 200, a distance difference δD between a position in which an output voltage level output from the light-receiving element 221 exceeds 0.6 V in a case where the gap is 4 mm and a position in which an output voltage level output from the light-receiving element 221 exceeds 0.6 V in a case where the gap is 7.5 mm is configured to be 0.07 mm. In addition, in the known PE sensor 200, a distance difference δD between a position in which an output voltage level output from the light-receiving element 221 exceeds 2.4 V in a case where the gap is 4 mm and a position in which an output voltage level output from the light-receiving element 221 exceeds 2.4 V in a case where the gap is 7.5 mm is configured to be 0.06 mm. In other words, due to the gap difference, the distance difference δD of positions at which the output voltage level exceeds 0.6 V is 0.07 mm and the distance difference δD of positions at which the output voltage level exceeds 2.4 V is 0.06 mm.

On the other hand, as shown in FIG. 10, in the PE sensor 100 according to this embodiment, a distance difference 6D between a position in which an output voltage level output from the light-receiving element 152 exceeds 0.6 V in a case where the gap is 4 mm and a position in which an output voltage level output from the light-receiving element 152 exceeds 0.6 V in a case where the gap is 7.5 mm is configured to be 0.02 mm. In addition, in the PE sensor 100 according to this embodiment, a distance difference δD between a position in which an output voltage level output from the light-receiving element exceeds 2.4 V in a case where the gap is 4 mm and a position in which an output voltage level output from the light-receiving element exceeds 2.4 V in a case where the gap is 7.5 mm is configured to be 0.06 mm. In other words, depending on the gap difference, the difference δD of positions at which the output voltage level exceeds 0.6 V is 0.02 mm and the difference of positions at which the output voltage level exceeds 2.4 V is 0.06 mm.

Accordingly, when the PE sensor 100 according to this embodiment is used, the threshold value and the difference of the detected positions, especially for 0.6 V, decreases, and it is possible to decrease the detection error.

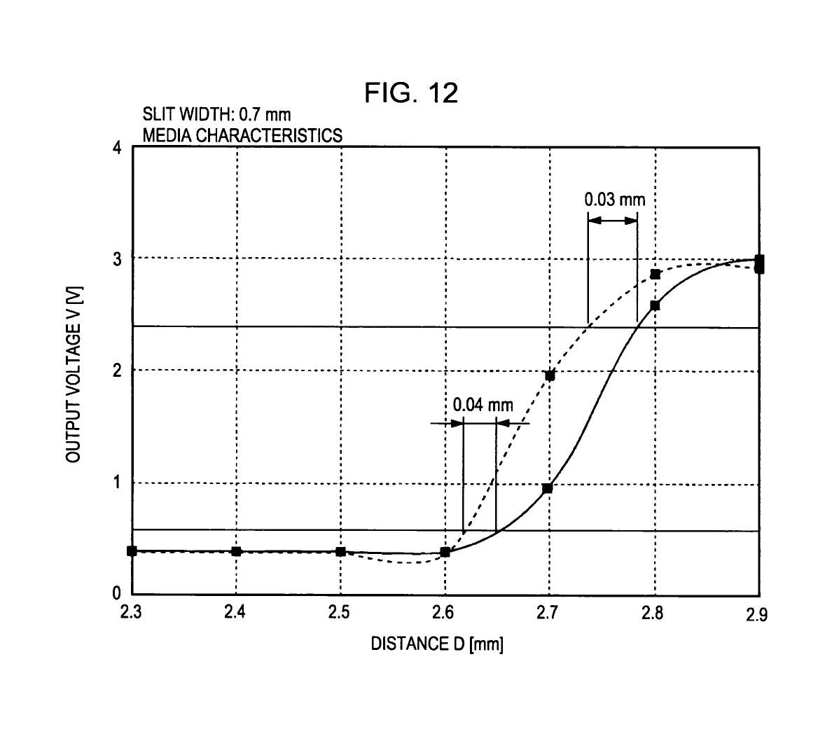

Subsequently, media characteristics (characteristics for the types of printing media P) of the PE sensors 100 and 200 will be described with reference to FIGS. 11 and 12. In FIGS. 11 and 12, a dotted line indicates a case where the printing medium P is plain paper, and a solid line indicates a case where the printing medium P is glossy paper. As shown in FIG. 11, in the known PE sensor 200, a distance between a position in which the voltage level output from the light-receiving element 221 exceeds 0.6 V in a case where the printing medium P is plain paper and a position in which the voltage level output from the light-receiving element 221 exceeds 0.6 V in a case where the printing medium P is glossy paper is configured to be 0.18 mm. In addition, in the known PE sensor 200, a distance between a position in which the voltage level output from the light-receiving element 221 exceeds 2.4 V in a case where the printing medium P is plain paper and a position in which the voltage level output from the light-receiving element 221 exceeds 2.4 V in a case where the printing medium P is glossy paper is configured to be 0.15 mm. In other words, depending on the difference between the types of the printing media P, a difference between positions in which the output voltage level exceeds 0.6 V is 0.18 mm, and a difference between positions in which the output voltage level exceeds 2.4 V is 0.15 mm.

On the other hand, in the PE sensor 100 according to this embodiment, a distance between a position in which the voltage level output from the light-receiving element 152 exceeds 0.6 V in a case where the printing medium P is plain paper and a position in which the voltage level output from the light-receiving element 152 exceeds 0.6 V in a case where the printing medium P is glossy paper is configured to be 0.04 mm. In addition, in the PE sensor 100 according to this embodiment, a distance between a position in which the voltage level output from the light-receiving element 152 exceeds 2.4 V in a case where the printing medium P is plain paper and a position in which the voltage level output from the light-receiving element 152 exceeds 2.4 V in a case where the printing medium P is glossy paper is configured to be 0.03 mm.

Accordingly, when the PE sensor 100 according to this embodiment is used, the difference between positions in which a threshold value of 0.6 V and a threshold value of 2.4 V are detected decreases, and it is possible to decrease the detection error. This decrease in the detection error is more remarkable than that in the above-described gap error.

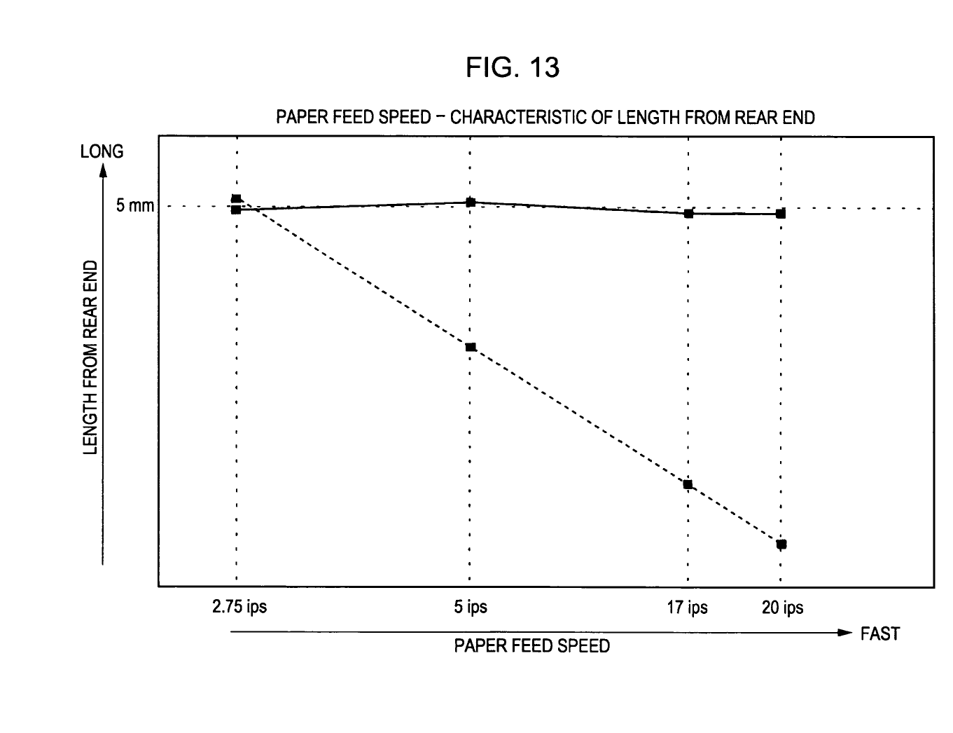

FIG. 13 is a diagram showing a relationship between paper feeding speed in the PE sensor 100 according to this embodiment and the known PE sensor 200 and a characteristic of length from a rear end. Here, the characteristic of length from a rear end indicates how far the actual printing completion position is located from the rear end of the printing medium in a case where the position (printing completion position) of an end portion in which a printing operation is completed is determined to be a predetermined distance (5 mm in FIG. 13) away from the rear end of the printing medium P. A solid line denotes a characteristic of the PE sensor 100 according to this embodiment. In addition, a dotted line denotes a characteristic of the known PE sensor 200 in which correction on the basis of the feeding speed is not performed.

As shown in FIG. 13, when the PE sensor 100 according to this embodiment is used, the actual printing completion position is 5 mm away from the rear end of the printing medium P on the whole as is determined in advance, and there is scarcely a change in the printing completion position among cases where the feeding speed is 2.75 ips, 5 ips, 17 ips, and 20 ips. The reason for this is that, when the PE sensor 100 is used, the end portion of the printing medium P in the transport direction is detected instantly. On the other hand, when the known PE sensor 200 is used, as the feeding speeds is increased to 2.75 ips, 5 ips, 17 ips, and 20 ips, the printing completion position approaches the rear end linearly (proportionally). Thus, when the known PE sensor 200 is used, correction on the basis of the paper feeding speed is required.

According to the PE sensor 100 and the printer 10 that have the above-described configuration, the end portion of the printing medium P in the transport direction thereof is detected by direct reach of the printing medium P between the light-emitting element 151 and the light-receiving element 152. Thus, it is possible to detect the end portion of the printing medium P in the transport direction instantly, which is different from a case where the known mechanical PE sensor 200 using rotation of a lever is used. Accordingly, it is possible to prevent occurrence of a problem that a predetermined time is required for rotation of a lever which occurs in a case where the mechanical PE sensor 200 is used. Therefore, it is possible to continuously transport the printing medium P at a high speed and to improve throughput of printing.

In addition, since a predetermined time for the rotation of a lever is not required, a predetermined correction operation for each transport speed of the printing medium P is not needed, unlike the known mechanical PE sensor 200. Accordingly, an operation for adjusting correction values for each paper feeding speed by actually transporting the printing medium P is not needed, and therefore it is possible to remove inconvenience for performing the adjustment operation.

In addition, since the end portion of the printing medium P in the transport direction thereof is detected between the light-emitting and receiving elements 151 and 152 of the PE sensor 100, collision between the printing medium P and a lever is removed, unlike in the mechanical PE sensor 200. Accordingly, in a case where the transport speed of the printing medium P increases, it is possible to prevent a damage of the printing medium P due to the collision and generation of a collision mark in the printing medium P.

In the above-described PE sensor 100, although distance (distance in the base) between the opposing faces 142a and 142b is configured to be 8 mm (about 8 mm), the distance may be in the range of 6 mm to 10 mm. By employing the distance in this range as the distance between the opposing faces 142a and 142b, a gap between the light-emitting element 220 and the light-receiving element 221 is wider than that in the known PE sensor 200. Thus, even in a case where the printing medium P is fed by one from among the front side paper feed mechanism 60, the rear side paper feed mechanism 70, and the reverse paper feed mechanism, collision of the printing medium P with the tubular portion 140 is suppressed, and thereby it is possible to transport the printing medium P in a smooth manner. In other words, it is possible to maintain passing of the printing medium in a smooth manner.

In addition, in the above-described PE sensor 100, although the optical axis L is provided in a position 16.5 mm (about 16.5 mm) spaced apart from the top 121 of the base portion 120, the optical axis L may be provided in a position in the range of approximately 14 mm to approximately 19 mm spaced apart from the top of the base portion. In such a case, it is possible to increase the distance between the optical axis L and the base portion 120, compared with a case where the known PE sensor 200 is used. Thus, it is possible to prevent generation of charges by frictional contact between the base portion 120 and the printing medium P more assuredly. Accordingly, the amount of the unwanted charges attached to the PE sensor 100 can be reduced, and it is possible to suppress deterioration of the detection precision of the printing medium P in the PE sensor 100. In addition, since the optical axis L is far spaced apart from the base portion 120, it is possible to reduce an effect of external light, compared with a case where the optical axis L is close to the base portion 120. Therefore, it is possible to improve the detection precision of the end portion of the printing medium P in the transport direction thereof.

In addition, as described above, in the PE sensor 100 according to this embodiment, the tubular portion 140 does not have a slit or the like, and thus, the light-emitting element 151 and the light-receiving element 152 can be covered completely. Accordingly, it is possible to prevent occurrence of paper jam and the like due to the printing medium P getting caught on a slit in a case where the slit is provided. Although, in the above-described PE sensor 100, the width of the slit 162 is configured to be 0.7 mm (about 0.7 mm), it is possible to configure the width in the range of approximately 0.6 mm to approximately 0.9 mm. In such a case, although the width of the slit 162 is larger than that of the slit 212 (width: 0.5 mm) included in the known PE sensor 200, the light-emitting element 151 and the light-receiving element 152 are covered with the tubular portion 140 in the PE sensor 100. Thus, in order to achieve excellent detection precision by using the PE sensor 100 according to this embodiment, the width of the slit 162 is required to be larger than that in the PE sensor 200. However, when the width of the slit 162 is increased too much, the amount of emitted light increases in a case where the printing medium P is thin, and accordingly, there is a problem that the detection precision of the end portion in the transport direction thereof deteriorates. Therefore, by configuring the width of the slit 162 in the range of approximately 0.6 mm to approximately 0.9 mm, as described above, it is possible to achieve an excellent detection precision.

The widths of slits 162 of the slit members 160 disposed in the tubular portions 140a and 140b are configured to be the same with each other. Thus, the slit members 160 for the tubular portions 140a and 140b are not needed to be identified, and accordingly, it is possible to commonly use the slit members 160. Therefore, it is possible to simplify a process of attachment of the slit members 160 to the tubular portions 140a and 140b.

Although an embodiment of the present invention has been described, various changes in form and details may be made in the invention. Hereinafter, they will be described.

In the above-described embodiment, a case where the front side paper feed mechanism 60, the rear side paper feed mechanism 70, and the reverse paper feed mechanism are provided as a unit for supplying the printing medium P is described. However, all of these paper feed mechanism are not required to be provided, and a configuration in which at least the front side paper feed mechanism 60 or the rear side paper feed mechanism 70 from among the paper feed mechanisms is provided may be used.

In the above-described embodiment, the light-emitting element 151 and the light-receiving element 152 are covered with the tubular portion 140 (housing 110) made of a resin. However, the configuration in which the light-emitting element 151 and the light-receiving element 152 are covered with the tubular portion 140 may not be used. For example, a configuration in which the PE sensor has a slit and light is received through the slit may be used, like the known PE sensor 200.

In the above-described embodiment, the reverse paper feed mechanism is constituted by a member provided below the paper feed hopper 71. However, the configuration of the reverse paper feed mechanism is not limited thereto, and various modifications may be made therein. For example, a configuration in which the transport path 63 is partially used as the reverse paper feed mechanism may be employed.

In the above-described embodiment, the configuration of the printer 10 in which the rear side paper feed roller 72 and the retard roller 73 are provided is used. However, the present invention is not limited to a printer having the rear side paper feed roller 72 and the retard roller 73. For example, a rear side paper feed roller whose side has an approximate letter “D” shape may be used in place of the retard roller 73.

The printer 10 described in the above embodiment may be a part of a multifunction device having a configuration including functions (a scanner function, a copier function, and the like) other than the printer function.

What is claimed is:

1. An optical sensor used for detecting an end portion of a medium, the optical sensor comprising:
a light-emitting unit for emitting light;
a light-receiving unit for receiving the light emitted by the light-emitting unit;
a first tubular portion and a second tubular portion, the first and second tubular portions made of a material capable of transmitting light, the first tubular portion covering the light-emitting unit and the second tubular portion covering the light-receiving unit; and
a base portion coupled to the first and second tubular portions,
wherein the distance between opposing faces of the first tubular portion and the second tubular portion is in the range of about 6 mm to about 10 mm, and
wherein the optical sensor detects an end portion of the medium when the end portion of the medium passes between the light-emitting unit and the light-receiving unit.

2. The optical sensor of claim 1 further comprising a control unit, wherein the light-receiving unit transmits to the control unit an output signal when the optical sensor detects the end portion of the medium and the control unit drives one or more motors for transporting the medium on the basis of the output signal.

3. The optical sensor of claim 1, wherein the distance between the opposing faces of the first and second tubular portions is about 8 mm.

4. The optical sensor of claim 1, wherein the each of the tubular portions has a top portion coupled to the base portion a bottom portion, and an approximately square-shaped cross-sectional area.

5. The optical sensor of claim 4, wherein the square-shaped cross-sectional area of each of the tubular portions reduces in width from the top portion to the bottom portion.

6. The optical sensor of claim 5, wherein the width of each of the tubular portions at the top end is about 5.15 mm and the width of each of the tubular portions at the bottom end is about 4.8 mm.

7. The optical sensor of claim 4, wherein the distance between the top portion and the bottom portion of each of the tubular portions is about 19.2 mm.

8. An optical sensor used for detecting a medium, the optical sensor comprising:
a light-emitting unit for emitting light;
a light-receiving unit for receiving the light emitted by the light-emitting unit and transmitting an output signal;
a first tubular portion and a second tubular portion, the first and second tubular portions made of a resin capable of transmitting light, the first tubular portion covering the light-emitting unit and the second tubular portion covering the light-receiving unit; and
a base portion coupled to each of the tubular portions,
wherein the optical sensor has an optical axis between the light-emitting unit and the light-receiving unit, the optical axis being approximately parallel to the base portion and positioned a distance of between approximately 14 mm to approximately 19 mm from the base portion, and
wherein the optical sensor detects an end portion of the medium when the end portion of the medium passes between the light-emitting unit and the light-receiving unit.

9. The optical sensor of claim 8, wherein the optical axis is positioned a distance of about 16.5 mm from the base portion.

10. An optical sensor used for detecting a medium, the optical sensor comprising:
a light-emitting unit for emitting light;
a light-receiving unit for receiving the light emitted by the light-emitting unit and transmitting an output signal;
a first tubular portion and a second tubular portion, the first and second tubular portions made of a resin capable of transmitting light, the first tubular portion covering the light-emitting unit and the second tubular portion covering the light-receiving unit; and
a base portion coupled to each of the tubular portions; and
a first and second slit member, each of slit members having a plurality of wall faces for blocking light,
wherein the first slit member covers the light-emitting unit and is disposed inside the first tubular portion and the second slit member covers the light-receiving unit and is disposed inside the second tubular portion, and each of the slit members having a slit on one face of the wall faces for allowing transmission of light, the width of each of the slits being in the range of about 0.6 mm to about 0.9 mm, and
wherein the optical sensor detects an end portion of the medium when the end portion of the medium passes between the light-emitting unit and the light-receiving unit.

11. The optical sensor according to claim 10, wherein the widths of the slits of the first and second slit members are the same.

12. The optical sensor of claim 10, wherein the first and second slit members are comprised of stainless steel.

13. The optical sensor of claim 10, wherein the bottom of each of the slit members is covered and coupled to the bottom of each of the tubular portions.

14. The optical sensor of claim 10, wherein the bottom of each of the slit members is covered and the bottom of each of the slit members is disposed near the bottom of each of the tubular portions, each of the slit members being locked in place inside the tubular portions.

15. The optical sensor of claim 10, wherein the width of each of the slits of the slit members is about 0.7 mm.

16. The optical sensor of claim 10, wherein the slits of the slit members face each other.

17. A device comprising:
the optical sensor according to claim 1 further including:
a transport unit for transporting the medium; and
a control unit that controls a motor included in the transport unit on the basis of optical sensor detection of an end portion of the medium in a transport direction of the medium.

18. The device of claim 17, wherein the device is a printer, a scanner, a facsimile machine, or a copier.

19. The device of claim 17, wherein the device comprises at least one of a printer, scanner, facsimile machine, and a copier.
